(19) United States
(12) Patent Application Publication
(10) Pub. No.: US 2021/0276712 A1
(43) Pub. Date: Sep. 9, 2021

(54) FLYING BODY SYSTEM EQUIPPED WITH PLURALITY OF CONNECTABLE FLYING BODIES

(71) Applicant: AERONEXT INC., Tokyo (JP)

(72) Inventor: Yoichi SUZUKI, Tokyo (JP)

(21) Appl. No.: 17/258,025

(22) PCT Filed: Jul. 17, 2018
(86) PCT No.: PCT/JP2018/026784

§ 371 Date: Jan. 5, 2021

(51) Int. Cl. B64C 39/02; B64D 47/00; B64D 3/00

(52) U.S. Cl. CPC B64C 39/024; B64D 47/00; B64C 2201/12; B64C 2201/027; B64D 3/00

(57) ABSTRACT

To provide a flying body in which a working part can be brought close to an appropriate distance from a work target the flying body system according to the present disclosure includes a first rotorcraft and a second rotorcraft. The first rotorcraft and the second rotorcraft are connected by a connecting cable. At least, the second rotorcraft includes a working part. The first rotorcraft and the second rotorcraft maintain the flight of the first rotorcraft and the second rotorcraft in a flight mode, and maintain the flight of the first rotorcraft while work is performed by a working unit even if the flight of the second rotorcraft is stopped in a work mode.

### TECHNICAL FIELD

The present disclosure relates to a flying body system including a plurality of connectable flying bodies.

### BACKGROUND ART

In recent years, various services have been provided using a rotorcraft such as a drone or an unmanned aerial vehicle (UAV) (hereinafter simply referred to as “rotorcraft”) used for various purposes. Such a rotorcraft can be provided with various working units such as a camera, a sensor, a sound collecting part, a sprayer, a speaker, and the like, and so the range of industrial use is being further expanded. In addition, there are models in which the rotorcraft is equipped with a large-capacity battery, fuel, a cable for receiving power from the outside, and the like for prolonged operation.

Patent Document 1 provides a device capable of efficient long-time flight by supporting a power supply cable via another flying body while enabling long-time flight by external power (for example, see Patent Document 1).

### PRIOR ART

### Patent Literature

Patent Document 1: International Patent Publication WO2017/094842 A1

### DESCRIPTION OF THE INVENTION

### Technical Problem

In Patent Document 1, a working flying body, a plurality of other flying bodies, and a ground power supply device are connected to a power supply cable. The plurality of other flying bodies play the role of supporting the power supply cable, so that the working flying body can efficiently fly for a long time without being restricted by the handling of the power supply cable.

However, the flying body of Patent Document 1 is connected by the cable to the power supply device provided on the ground and cannot fly freely. Further, when the working flying body is to be used for various purposes, the operation is affected various effects such as wind or sound generated from the flying body.

Depending on an operation content, wind and sound generated from the flying body may affect a target, and so the operation itself cannot be performed. In addition, when the work space is narrow, the flying body might not be able to enter, or there is a possibility that risks such as contact may accompany the entering.

Therefore, the present disclosure is directed to provide a flight system wherein a working flying body connected by a cable from a supporting flying body is provided separately, wherein the supporting flying body maintains a distance from a work target, and while maintaining a position where safe flying is possible, the supporting flying body approaches the work target in an appropriate distance and enables an action suitable for the operation.

### Technical Solution

According to the present disclosure, there can be provided a rotorcraft system including a first rotorcraft and a second rotorcraft, wherein the first rotorcraft and the second rotorcraft are connected by a connecting cable.

### Advantageous Effects

According to the present disclosure, a flight system may be provided, wherein a working flying body connected by a cable from a flying body having a support function is provided separately, wherein while the flying body having a support function maintains a distance from a work target and also maintains a position where safe flying is possible, the working flying body approaches the work target in an appropriate distance and enables an action suitable for an operation.

### BRIEF DESCRIPTION OF THE DRAWINGS

FIG. 1 is a side view of a flying body system according to the present disclosure.

FIG. 2 is another side view of the flying body system of FIG. 1.

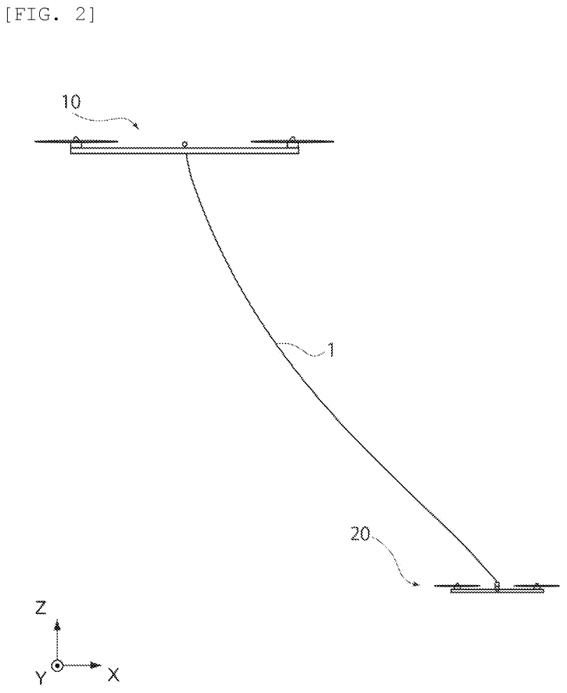

FIG. 3 is a view of the flying body system of FIG. 2 as viewed from above.

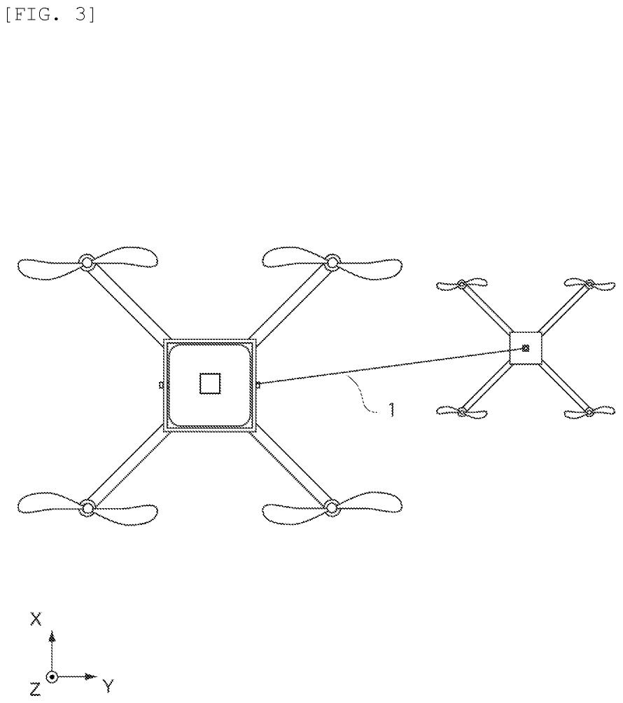

FIG. 4 is a view illustrating a usage example of the flying body system of FIG. 1.

FIG. 5 is a view in which another first rotorcraft is connected to a cable in the flying body system of FIG. 1.

FIG. 6 is a view illustrating a replacement operation in the flying body system of FIG. 1. A mode is shown in which a first rotorcraft is separated from the cable and replaced with another first rotorcraft.

FIG. 7 is a view of an example of a rotorcraft used in the flying body system according to the present disclosure as seen from above.

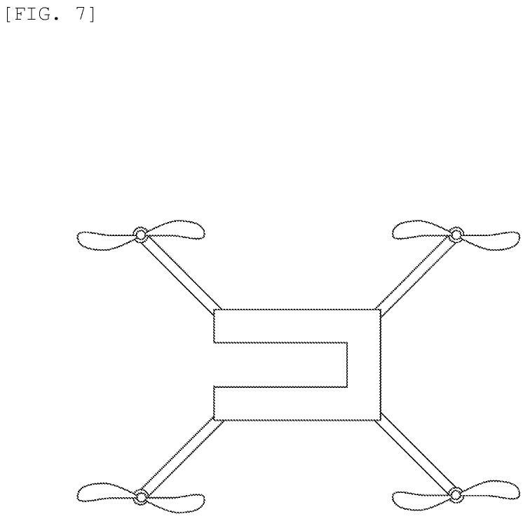

FIG. 8 is a view illustrating another replacement operation in the flying body system according to the present disclosure.

FIG. 9 is a view illustrating still another replacement operation in the flying body system according to the present disclosure.

FIG. 10 is a view illustrating still another replacement operation in the flying body system according to the present disclosure.

FIG. 11 is a view illustrating another embodiment of the flying body system according to the present disclosure.

FIG. 12 is a functional block diagram of a rotorcraft used in the flying body system according to the present disclosure.

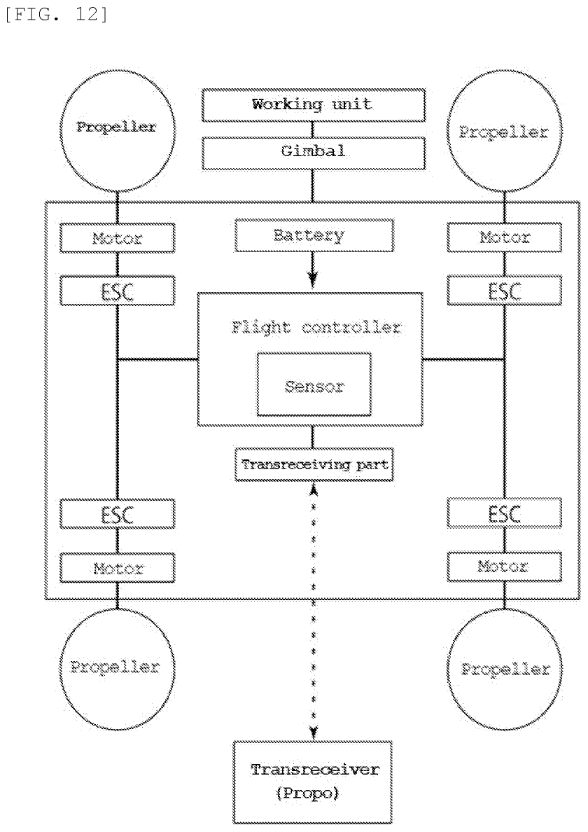

### DETAILED DESCRIPTION OF THE INVENTION

The contents of the embodiment of the present disclosure will be listed and described. A flying body system including a plurality of connectable flying bodies according to an embodiment the present disclosure has the following configuration.

### Item 1

A rotorcraft system which is a flying body system including a first rotorcraft and a second rotorcraft wherein the first rotorcraft and the second rotorcraft are connected by a connecting cable.

### Item 2

The rotorcraft system as set forth in Item 1,

wherein the second rotorcraft includes a working part.

### Item 3

The rotorcraft system as set forth in Item 2,

wherein the first rotorcraft and the second rotorcraft maintain the flight of the first rotorcraft and the second rotorcraft in a flight mode, and maintain the flight of the first rotorcraft while work is performed by the working part in a work mode even if the flight of the second rotorcraft is stopped in a work mode.

### Item 4

The rotorcraft system as set forth in Item 2,

wherein the working part is a sound collecting part, and in work mode, the first rotorcraft and the second rotorcraft are configured to be mutually spaced apart so that the sound generated from the first rotorcraft is prevented from entering the sound collecting part.

### Item 5

The rotorcraft system as set forth in any one of Items 1 to 3, wherein the first rotorcraft has a first connecting part connected to the connecting cable,

the second rotorcraft has a second connecting part connected to the connecting cable, and

at least any one of the first connecting part or the second connecting part is capable of swinging independently from the second rotorcraft or the first rotorcraft, respectively, within a predetermined range.

### Item 6

The rotorcraft system as set forth in Item 1, wherein the second rotorcraft is supplied with power from the first rotorcraft via the connecting cable.

### Item 7

The rotorcraft system as set forth in any one of Items 1 to 6,

wherein the connecting cable is connectable to another first rotorcraft.

### Item 8

The rotorcraft system as set forth in Item 7,

wherein the first rotorcraft is configured to disconnected from the connecting cable after the connecting cable is connected from the first rotorcraft to the other first rotorcraft.

### Item 9

The rotorcraft system as set forth in any one of Items 1 to 8,

wherein the connecting cable is connectable to another second rotorcraft.

### Item 10

The rotorcraft system as set forth in Item 9,

wherein the second rotorcraft is configured to be disconnected from the connecting cable after the connecting cable connected from the second rotorcraft to the other second rotorcraft.

### Details of Embodiments According to the Disclosure

Hereinafter, a flying body system including a plurality of connectable flying bodies according to embodiments of the present disclosure will be described with reference to the accompanying drawings.

### Details of Embodiments According to the Disclosure

Hereinafter, a flying body system including a plurality of connectable flying bodies according to embodiments of the present disclosure will be described with reference to the accompanying drawings.

### First Embodiment of the Present Disclosure

The flying body system according to an embodiment of the present disclosure includes a first rotorcraft 10 and a second rotorcraft 20, wherein the first rotorcraft 10 and the second rotorcraft 20 are connected by a connecting cable 1. At this time, the number of the first rotorcraft 10 and the second rotorcraft 20 may be plural, and each may be or may not be a proportional number. For example, it could be sire second rotorcrafts 20 with respect to one first rotorcraft 10 or vice versa.

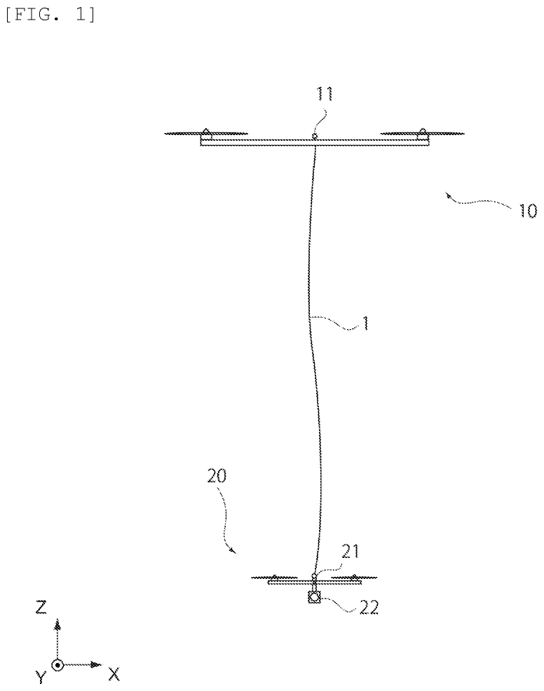

As shown in FIG. 1, the second rotorcraft 20 includes a working part 22 connected to the main body part, an can perform a predetermined work. Examples of the work part 22 and work performed by the working part 22 include photographing, monitoring, investigating and recording by information acquiring devices capable of acquiring external information such as a camera, a sensor, and a microphone, or spraying liquid, and coating, fire extinguishing, giving water to animals and plants by a sprayer, a spraying device, a water discharge device, or interference with the outside by a speaker, an odor generator, a light emitting device, or work, maintenance, or moving an object by a tool or robot arm, and the like, but is not limited thereto.

Each of the first rotorcraft 10 and the second rotorcraft 20 can maintain the flight of its own flying body (flight mode).

In addition, the first rotorcraft 10 maintains the flight of its own flying body while the second rotorcraft 20 stops flying, and at the same time, the second rotorcraft 20 is maintained in the air by the mutually connected connecting cable 1 to perform work (work mode).

In the work mode, the second rotorcraft 20 performs work using the working part 22. Even when the second rotorcraft 20 stops flying, it can stay in the air due to the first rotorcraft 10, and in using the working part 22 of the second rotorcraft 20, the work can be performed without being affected by various effects such as sound, wind or magnetism generated by the second rotorcraft 20 during flight.

When the working part 22 is a sound collecting part such as a microphone, in the working mode, the first rotorcraft and the second rotorcraft 20 are configured to be separated from each other sufficiently, so that the sound generated from the first rotorcraft 10 is prevented from entering the sound collecting part, and a good result of the work is obtained. In other words, the distance between each other is set at a position where the sound generated by the first rotorcraft 10 does not enter the working part 22 as the sound collecting part.

As an example, in the work using the sound collecting part, first, the first rotorcraft 10 and the second rotorcraft 20 connected by the connecting cable 1 start flying from the takeoff point. After moving in flight mode to the point where the sound collection work is performed, the mode is shifted to work mode to perform the sound collection work. After completing the work, they fly to the landing point and land. In addition, when work points are a plural, it is possible to perform the work efficiently during one flight by repeating moving and working by switching the flight mode and the work mode.

The first rotorcraft 10 includes a first connecting part 11 connected to the connecting cable 1. Further, the second rotorcraft 20 includes a second connecting part 21 connected to the connecting cable 1. At least one side of any of the first connecting part 11 and the second connecting part 21 is capable of swinging independently from the second rotorcraft 20 or the first rotorcraft 10, respectively, within a predetermined range. Thus, a flexible and safe flight is made possible without being restricted by mutual flight postures.

### Second Embodiment of the Present Disclosure

In the details of the second embodiment according to the present disclosure, the same components as those in the first embodiment perform the similar operation, and thus another description thereof is omitted.

The connecting cable 1 only needs to connect the first rotorcraft 10 and the second rotorcraft 20. For example, when an electric wire or a composite cable that can supply power is used, it is possible for the second rotorcraft to receive power from the first rotorcraft through the connecting cable 1.

When flying a flying body for a long time, it is necessary to provide a battery and/or fuel according to the situation and the length of time. However, the second rotorcraft 20 that performs the work may be required to be small or maneuverable. For example, there are operations such as intruding into a narrow space or working in a state of being unrecognized by a work target such as living things. At that time, it may be disadvantageous to be provided with a large battery or the like. Therefore, if the first rotorcraft 10 is equipped with a large battery and the second rotorcraft 20 is powered by a connecting cable, it is possible for the second rotorcraft 20 to fly for a long time, and be compatible to be light and small.

When the second rotorcraft 20 is equipped with a battery or the like necessary for the flight of its own flying body, it can maintain its flight state even if the power supply from the first rotorcraft 10 is interrupted. In addition, when changing connections from the first rotorcraft 10 to another first rotorcraft 12, it is possible to fly and move by itself. The change of the connections will be described later.

### Third Embodiment of the Present Disclosure

The flying body system according to the third embodiment of the present disclosure can replace the first rotorcraft 10 with another first rotorcraft (hereinafter, regardless of whether it is the first rotorcraft or the second rotorcraft being replaced, the work of replacing with another rotorcraft is simply referred to as “replacement operation”). In the details of the third embodiment according to the present disclosure, the same components those in the first embodiment perform the similar operation, and thus another description thereof is omitted.

The replacement operation method according to the present embodiment includes a method of replacing the first rotorcraft 10 with another first rotorcraft 10, a method of replacing the second rotorcraft with another second rotorcraft, and may illustrate both. In addition, the other first rotorcraft 10 and second rotorcraft may be multiple units.

The second rotorcraft 20 can also be connected to other first rotorcrafts 12 via the connecting cable 1. For example, the first rotorcraft 10 with a low battery level is connected to another first rotorcraft 12 with a higher battery level, and then by connecting to another flying body when the remaining battery level decreases, it is made possible to work for a long time. In particular, when the takeoff point and the point where the work is performed are apart, the reciprocation of the second rotorcraft 20 does not occur, and the work can be performed efficiently.

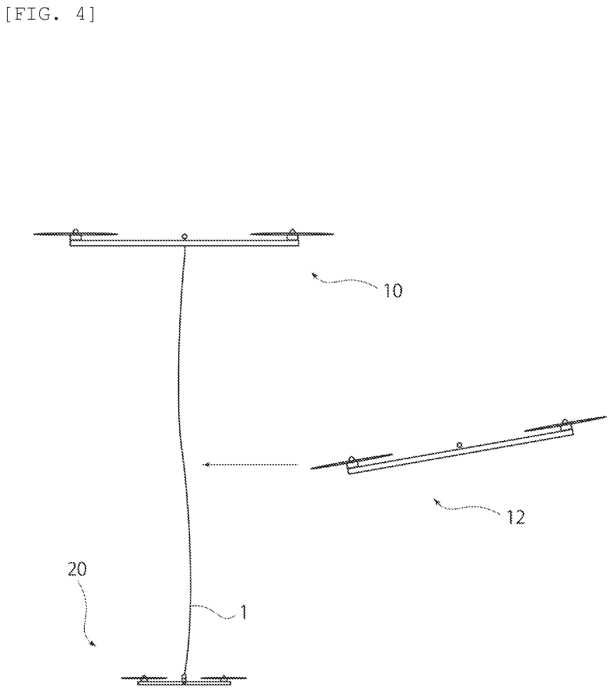

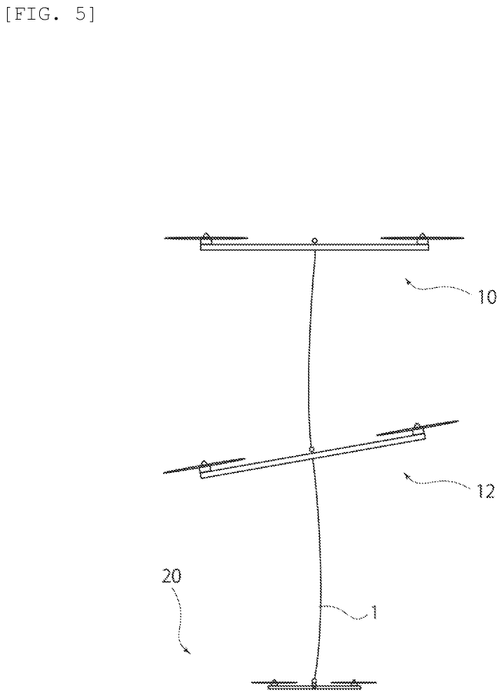

As shown in FIGS. 4 to 6, the first rotorcraft 10 can be disconnected from the connecting cable 1 after another first rotorcraft 12 is connected to the connecting cable 1. In this way, the second rotorcraft 20 can always be continuously connected to at least one first rotorcraft 10 or other first rotorcraft 12. As a result, the time for the second rotorcraft 20 to fly with its own battery can be reduced, and the active time of the second rotorcraft 20 can be extended. Other flying body connection methods will be described later.

### Fourth Embodiment of the Present Disclosure

In the details of the fourth embodiment according to the present disclosure, the same components as those in the first embodiment perform the similar operation, and thus the description thereof will be omitted.

The first rotorcraft 10 can also be connected to another second rotorcraft 23 via the connecting cable 1. For example, in a situation where the connecting cable 1 becomes an obstacle to the flight or work, the second rotorcraft 20 or the other second rotorcraft 23 operates with a battery or the like provided in its own flying body. When the remaining battery level decreases, the second rotorcraft 20 connects to the first rotorcraft 10 and receives power. When the power supplying is completed, it is possible that another second rotorcraft 23 is connected to the first rotorcraft 10 to receive power. The connection of the flying body will be described later.

The second rotorcraft 20 can be disconnected from the connecting cable 1 after another second rotorcraft 23 is connected to the connecting cable 1. In this way, the first rotorcraft 10 can always be continuously connected to at least one or more second rotorcrafts 20 or another second rotorcraft 23. Since the first rotorcraft 10 that performs power supply or the like is also flying, by connecting to the second rotorcraft 20 or another second rotorcraft 23 without intervals, for example, the amount of time flying by its own flying body without power supply is reduced, and battery usage efficiency is improved. Other flying body connection methods will be described later.

A part of the flying body connection method is exemplified below. In the illustration, there is an example described only with the names of the first rotorcraft 10, the other first rotorcraft 12, the second rotorcraft 20, and the other second rotorcraft 23, but as described above, since there are cases in which the second rotorcraft 20 connected to the first rotorcraft 10 is newly connected to another first rotorcraft 12, and the first rotorcraft 10 connected to the second rotorcraft 20 is newly connected to another second rotorcraft 23, unless there is a contradiction in light of the spirit of the present disclosure, the first rotorcraft 10, the other first rotorcraft 12, the second rotorcraft 20, and the other second rotorcraft 23 can be respectively replaced and read by the second rotorcraft 20, the other second rotorcraft 23, the first rotorcraft 10, and the other first rotorcraft 12.

### EXAMPLE 1

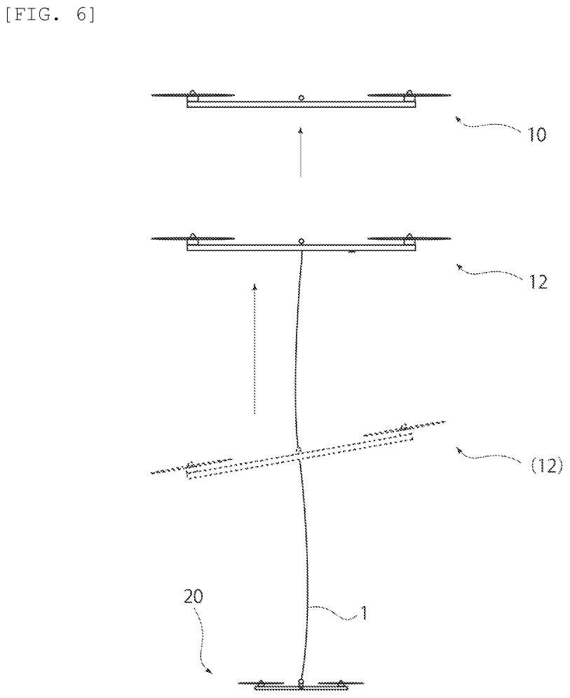

As shown in the usage examples of FIGS. 4 to 6, a method in which the other first rotorcraft 12 is connected to the connecting cable 1 between the first rotorcraft 10 and the second rotorcraft 20, and the first rotorcraft 10 is disconnected above the connecting cable 1. At this time, for example, as shown in FIG. 6, when the other first rotorcraft 12 is shaped to have a gap where a cable having a shape such as substantially channel-shaped, other substantially C-shaped, or substantially U-shaped, as viewed from above can pass through, the connection can be easily performed.

### EXAMPLE 2

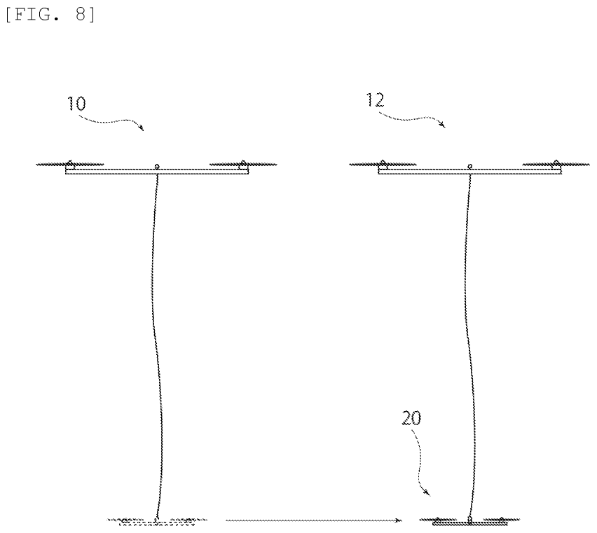

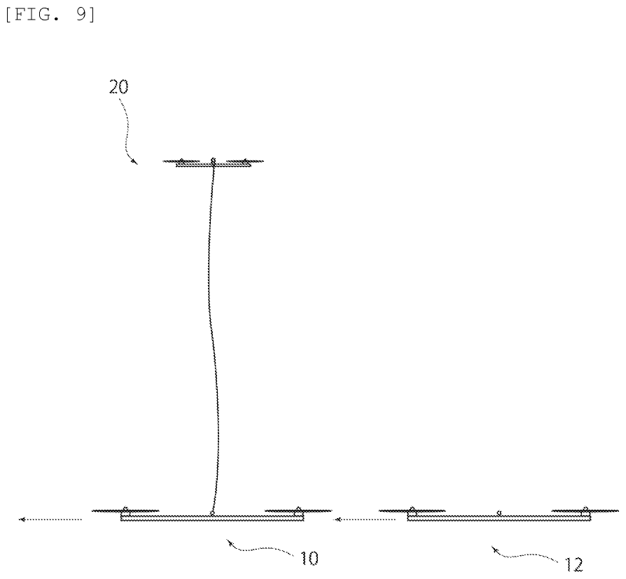

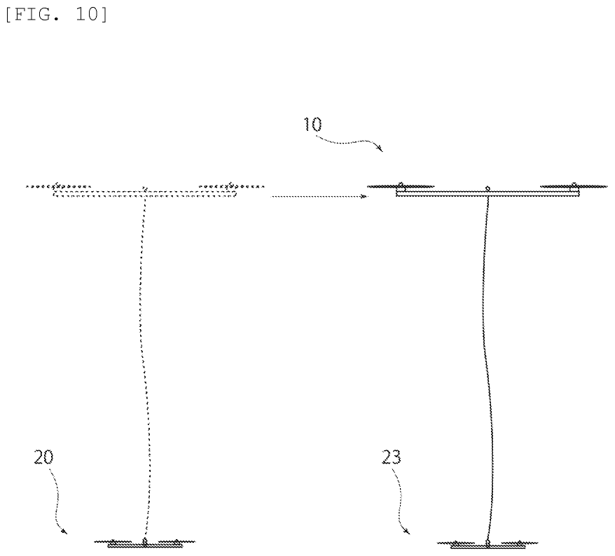

As shown in FIGS. 8 to 10, a method in which the second rotorcraft 20 is disconnected from the connecting cable 1 connected to the first rotorcraft 10 and is connected to the connecting cable 1 connected to the other first rotorcraft 12. Further, a method in which the first rotorcraft 10 is disconnected from the connecting cable 1 connected to the second rotorcraft 20, and another first rotorcraft 12 is newly connected to the connecting cable 1.

### EXAMPLE 3

A method in which the other first rotorcraft 12 approaches an upper side or lateral side of the first rotorcraft 10 connected to the second rotorcraft 20, the transfer of the connecting cable 1 from the first rotorcraft 10 to the other first rotorcraft 12 is performed, and the other first rotorcraft 12 is newly connected to the connecting cable 1. Further, when the connecting cable 1 is delivered, the cable may be bent depending on the rigidity of the cable, which may cause a problem in delivery, so in addition to designing a portion of the connecting cable 1 related to delivery so as not to bend, it is preferable to prevent bending of the cable using an auxiliary tool.

### EXAMPLE 4

A method in which the connecting cable 1 connected to the first rotorcraft 10 is branched into two or more branches, and the other first rotorcraft 12 is newly connected to a cable end other than the cable end to which the second rotorcraft 20 is connected.

### EXAMPLE 5

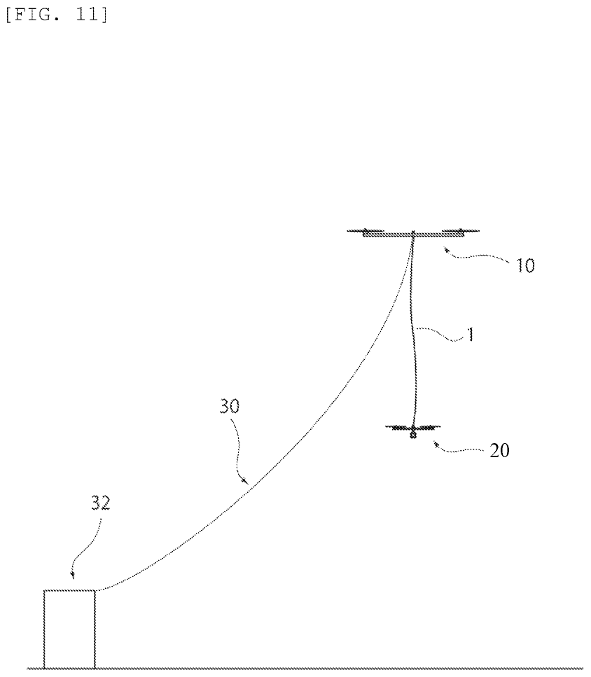

As shown in FIG. 11, the first rotorcraft 10 may perform hovering or the like in the air while being supplied with power by a power supply cable (ground power supply cable) 30 from a ground power supply device (facility). The second rotorcraft 20 receives power from the first rotorcraft that is always waiting in the air from the connecting cable 1 and performs work. In this case, since the first rotorcraft 10 does not need to perform a replacement operation at least for power supply, the second rotorcraft 20 can be engaged with more maneuverability in the work.

The above-described rotorcraft (first rotorcraft 10 and second rotorcraft 20) has, for example, a functional block as shown in FIG. 11. In addition, the functional block of FIG. 11 is minimum reference configuration. A flight controller is a so-called processing unit. The processing unit may have one or more processors, such as a programmable processor (e.g., a central processing unit (CPU)). The processing unit has a memory that is not shown and it is possible to access the memory. The memory stores logic, codes, and/or program instructions that can be executed by the processing unit to perform one or more steps. The memory may include, for example, a separable medium or an external storage device such as an SD card or random access memory (RAM). Data obtained from cameras and sensors may be transmitted directly to the memory and stored. For example, still image·dynamic image data taken by a camera or the like is recorded in a built-in memory or an external memory.

The processing unit includes a control module configured to control the state of the rotorcraft. For example, the control module may control a propulsion mechanism (such as a motor) in order to adjust the spatial arrangement, velocity, and/or acceleration of the rotorcraft having six degrees of freedom (translational motions x, y, and z, and rotational motions θx, θy, and θz). The control module can control one or more of the states of a mounting part and sensors.

The processing unit can communicate with a transreceiving part configured to send and/or receive data from one or more external devices (e.g., a terminal, display device, or other remote controller). The transreceiver can use any suitable communication means such as wired or wireless communication. For example, the transreceiving part can use one or more of a local area network (LAN), a wide area network (WAN), infrared, wireless, WiFi, point-to-point (P2P) network, telecommunication network, cloud communication, and the like. The transreceiving part can transmit and/or receive one or more of, data acquired by sensors, process results generated by the processing unit, predetermined control data, user command from a terminal or a remote controller, and the like.

Sensors according to the present embodiment may include an inertial sensor (an acceleration sensor, a gyro sensor), a GPS sensor, a proximity sensor (e.g., LiDAR), or a vision/image sensor (e.g., a camera).

The rotorcraft of the present disclosure can be expected to be used as a rotorcraft for monitoring and investigation work, and as an industrial rotorcraft in warehouses, factories or outdoors. In addition, the rotorcraft of the present disclosure can be used in airplane-related industries such as multicopters and drones. Furthermore, the present disclosure can be used as a rotorcraft for investigation equipped with a camera or the like, and also can be used in various industries such as security, agriculture, research, in case of disaster, and infrastructure monitoring.

The above-described embodiments are merely examples for facilitating the understanding of the present disclosure and are not intended to limit the present disclosure. The present disclosure can be modified and improved without departing from the gist thereof, and it goes without saying that the equivalents are included in the present disclosure.

The above-described embodiments are merely examples for facilitating the understanding of the present disclosure and are not intended to the present disclosure. The present disclosure can be modified and improved without departing from the gist thereof, and it goes without saying that the equivalents are included in the present disclosure.

### DESCRIPTION OF REFERENCE NUMERALS

1 connecting cable

10 first rotorcraft

11 first connecting part

12 other first rotorcraft

20 second rotorcraft

21 second connecting part

22 working part

23 other second rotorcraft

1. A rotorcraft system which is a flying body system comprising:
a first rotorcraft and a second rotorcraft,
wherein the first rotorcraft and the second rotorcraft are connected by a connecting cable.

2. The rotorcraft system according to claim 1,
wherein the second rotorcraft includes a working part.

3. The rotorcraft system according to claim 2,
wherein the first rotorcraft and the second rotorcraft maintain the flight of the first rotorcraft and the second rotorcraft in a flight mode; and maintain the flight of the first rotorcraft and stop the flight of the second rotorcraft while work is performed by the working part in a work mode.

4. The rotorcraft system according to claim 2,
wherein the working part is a sound collecting part,
the first rotorcraft and the second rotorcraft are configured to be mutually spaced apart so that the sound generated from the first rotorcraft is prevented from entering the sound collecting part.

5. The rotorcraft system according to claim 1,
wherein the first rotorcraft has a first connecting part connected to the connecting cable,
the second rotorcraft has a second connecting part connected to the connecting cable,
and at least any one of the first connecting part and the second connecting part is capable of swinging independently from the second rotorcraft or the first rotorcraft, respectively, within a predetermined range.

6. The rotorcraft system according to claim 1,
wherein the second rotorcraft is supplied with power from the first rotorcraft via the connecting cable.

7. The rotorcraft system according to claim 1,
wherein the connecting cable is connectable to another first rotorcraft.

8. The rotorcraft system according to claim 7,
wherein the first rotorcraft is configured to be disconnected from the connecting cable after the connecting cable is connected to the other first rotorcraft.

9. The rotorcraft system according to claim 1,
wherein the connecting cable is connectable to another second rotorcraft.

10. The rotorcraft system according to claim 9,
wherein the second rotorcraft is configured to be disconnected from the connecting cable after the connecting cable is connected to the other second rotorcraft

11. The rotorcraft system according to claim 3,
wherein the working part is a sound collecting part,
and in the work mode, the first rotorcraft and the second rotorcraft are configured to be mutually spaced apart so that the sound generated from the first rotorcraft is prevented from entering the sound collecting part.

12. The method comprising: connecting a first rotorcraft and a second rotorcraft by a connecting cable,
wherein the second rotorcraft is located below the first rotorcraft while flying.

13. The method according to claim 12,
wherein the second rotorcraft includes a working part,
wherein the second rotorcraft performs a predetermined work by the working part.

14. The method according to claim 13,
wherein the first rotorcraft and the second rotorcraft maintain the flight of the first rotorcraft and the second rotorcraft in a flight mode; and maintain the flight of the first rotorcraft and stop the flight of the second rotorcraft while work is performed by the working part in a work mode.

15. The method according to claim 13,
wherein the working part is a sound collecting part,
and the first rotorcraft and the second rotorcraft are configured to be mutually spaced apart so that the sound generated from the first rotorcraft is prevented from entering the sound collecting part.

16. The method according to claim 14,
wherein the working part is a sound collecting part,
and in the work mode, the first rotorcraft and the second rotorcraft are configured to be mutually spaced apart so that the sound generated from the first rotorcraft is prevented from entering the sound collecting part.

17. The method according to claim 12,
wherein the first rotorcraft has a first connecting part connected to the connecting cable,
the second rotorcraft has a second connecting part connected to the connecting cable,
and at least any one of the first connecting part and the second connecting part is capable of swinging independently from the second rotorcraft or the first rotorcraft, respectively, within a predetermined range.

18. The method according to claim 12,
wherein the second rotorcraft is supplied with power from the first rotorcraft via the connecting cable.

19. The method according to claim 12,
wherein the connecting cable is connectable to another first rotorcraft,
wherein the first rotorcraft is configured to be disconnected from the connecting cable after the connecting cable is connected to the other first rotorcraft.

20. The method according to claim 12,
wherein the connecting cable is connectable to another second rotorcraft.
wherein the second rotorcraft is configured to be disconnected from the connecting cable after the connecting cable is connected to the other second rotorcraft.
